(19) United States
(12) Patent Application Publication
(10) Pub. No.: US 2008/0058009 A1
(43) Pub. Date: Mar. 6, 2008

(54) Hand-held electronic device with multi-functions

(75) Inventors: Shin-Bin Ko, Taipie (TW); Yung-Hung Lin, Taipei (TW); An-Chi Chang, Taipei (TW)

Correspondence Address: REED SMITH LLP;Suite 1400, 3110 Fairview Park Drive, Falls Church, VA, 22042, US

(73) Assignee: Compal Communications, Inc.

(21) Appl. No.: 11/896,585

(22) Filed: Sep. 4, 2007

(30) Foreign Application Priority Data
Sep. 5, 2006 (TW) 095215749

(51) Int. Cl. H04M 1/00

(52) U.S. Cl. 455/556.1

(57) ABSTRACT

The invention relates to a hand-held electronic device with multi-functions comprising a casing, a display pivotally configured on the casing and capable of being rotated in different angles, a control circuit configured in the casing, an optical projecting system configured in the casing and electrically connected to the control circuit, and an optical video recording and photographing system. The casing has a plurality of operable keys. The control circuit is capable of executing functions of communication according to the operation of each of the keys, projection by driving the optical projecting system, and video recording and photographing by driving the optical video recording and photographing system. Accordingly, functions of communication, projection, video recording, and photographing can be selectively executed, so as to achieve the effect of multi-functions in one set.

### BACKGROUND OF THE INVENTION

1. Field of the Invention

The invention relates to a hand-held electronic device and, more particularly, to a hand-held electronic device with multi-functions capable of providing functions of communication, projection, video recording, and photographing.

2. Description of the Prior Art

The mobile phone at the earliest stage provided only the function of communication. Of late, mobile phones are capable of taking a photo, sending and receiving e-mails via wireless network, having personal digital assistant (PDA) function, and so on. A business person has to carry a mobile phone with him for business, and sometimes, for the purpose of making a presentation to the customer, he needs to carry a projector and a notebook, too. Therefore, the briefcase is bulging and heavy and creates a great burden for the business person on a business trip.

Hence, the inventor ponders on a mobile phone combining functions of communication, projection, video recording, photographing, and so on, so the business person can rely on his mobile phone, which is a requirement, for making presentation, communication, video recording, and photographing all at once.

### SUMMARY OF THE INVENTION

Therefore, a purpose of the invention is to provide a hand-held electronic device with multi-functions for selectively executing functions of communication, projection, video recording, and photographing, so as to achieve the effect of installing multi-functions in one set.

Hence, the hand-held electronic device with multi-functions of the invention comprises:

a casing with a plurality of operable keys;

a display pivotally configured on the casing and capable of rotating in different angles;

a control circuit configured in the casing and capable of selectively executing functions of communication, projection, video recording, and photographing;

an optical projecting system, configured in the casing and electrically connected to the control circuit, is capable of being driven by the control circuit to execute the function of projection; and

an optical video recording and photographing system, configured in the casing and electrically connected to the control circuit, is capable of being driven by the control circuit to execute the functions of video recording and photographing according to the operation of the keys.

Accordingly, the invention provides executing functions of communication, projection, video recording, and photographing that can be selected, so as to achieve effect of installing multi-functions in one set.

The advantage and spirit of the invention may be understood by the following recitations together with the appended drawings.

### BRIEF DESCRIPTION OF THE APPENDED DRAWINGS

FIG. 1 is a schematic diagram illustrating a hand-held electronic device with multi-functions according to a preferred embodiment of the invention;

FIG. 2 is a back view of the preferred embodiment;

FIG. 3 is a side view illustrating that the hand-held electronic device is placed on a loader in the preferred embodiment;

FIG. 4 is a schematic diagram illustrating that a display pivots to where a screen is located on the front of the casing for a user to watch in the preferred embodiment;

FIG. 5 is a schematic diagram illustrating that the display is capable of being pivoted and opened toward the user when photographing in the preferred embodiment;

FIG. 6 is a schematic diagram illustrating that two feet of the stand frame are at an open position in the preferred embodiment; and

FIG. 7 is a top view illustrating that the stand frame is opened and placed on the loader, and a zoom lens is configured on a video lens in the preferred embodiment.

### DETAILED DESCRIPTION OF THE INVENTION

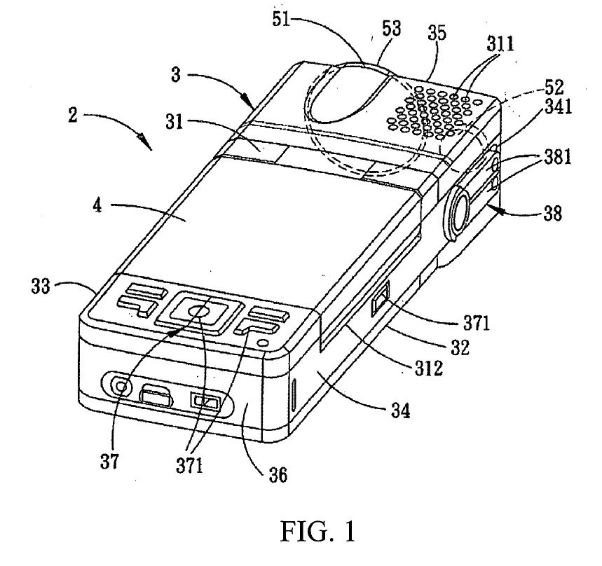

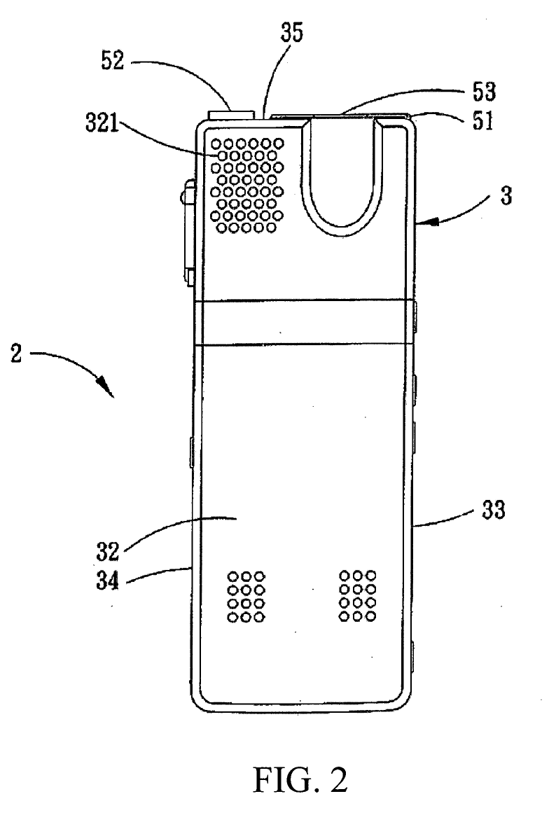

Please refer to FIG. 1 and FIG. 2. FIG. 1 and FIG. 2 are the schematic diagrams illustrating a hand-held electronic device 2 with multi-functions according to a preferred embodiment of the invention. In this embodiment, the hand-held electronic device 2 is illustrated with a mobile phone. The hand-held electronic device 2 comprises a casing 3, a display 4 pivotally configured on the casing 3 and capable of be rotated in different angles, a control circuit (not shown in the figures) configured in the casing 3, an optical projecting system (not shown in the figures), and an optical video recording and photographing system (not shown in the figures).

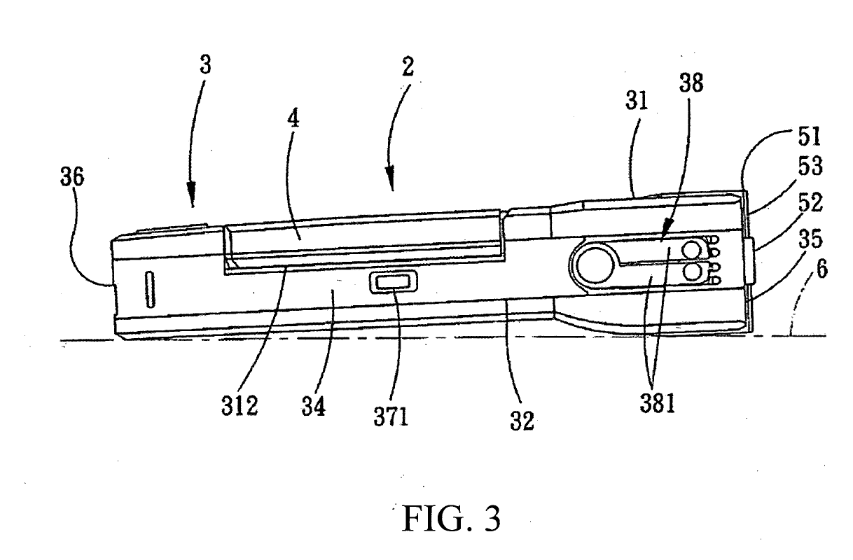

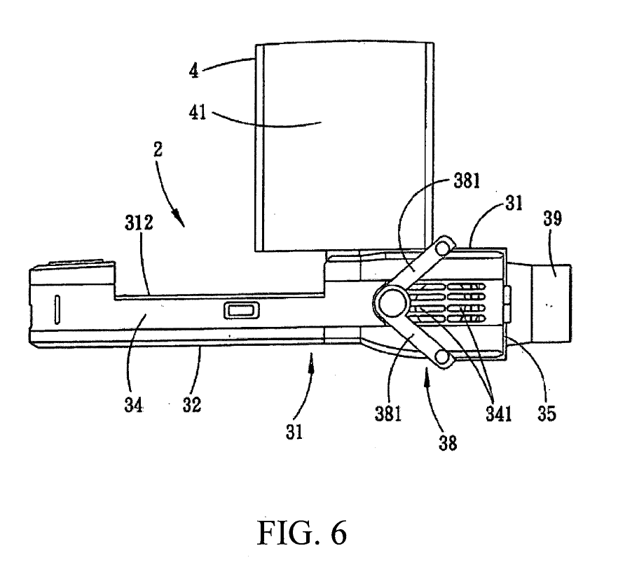

The casing 3 has a front side 31, a back side 32 opposite to the front side 31, two corresponding flank side 33 and 34, a top side 35, and a bottom side 36. The front side 31 and the back side 32 comprise a plurality of outlet holes 311 and 321 formed thereon and near the top side 35, and the flank side 34 comprises a plurality of inlet holes 341 formed thereon. The front side 31 and the two flank side 33 and 34 respectively comprise at least one operable key 37 formed thereon, and the operable keys 37 comprise a plurality of functional keys 371. The functional keys 371 are capable of being operated respectively for selectively executing functions of adjusting volume, direction, brightness, or viewing the function list, and so on. The front side 31 further forms a hollow area 312 thereon. Besides, the flank side 34 of the casing 3 pivotally configures a stand frame 38 thereon, and the stand frame 38 has two feet 381 capable of being pivoted and moved between a close position (as shown in FIG. 1 and FIG. 3) and an open position (as shown in FIG. 6).

A side of a display 4 is pivotally configured on the casing 3 and near the hollow area 312, and the display 4 is capable of being rotated in different angles corresponding to the casing 3. In this embodiment, the display 4 is illustrated with a touch screen. Therefore, no matter it is dialing, projecting, video recording, or photographing, a user is capable of making his selection via screen options of the display 4 and press the suitable functional key 371. Surely the display 4 can be an LCD, and at this time the above-mentioned keys 37 further comprise a plurality of number keys (not shown in the figures) configured in the hollow area 312 of the casing 3, so as to provide functions of dialing for communication or selecting the screen options.

An optical projecting system is configured in the casing 3 and electrically connected to the control circuit, and the optical projecting system comprises an optical engine (not shown in the figure) configured in the casing 3, a projecting lens 51 exposed out of the casing 3 and capable of projecting the image generated by the optical engine, and a cover 53 for covering the projecting lens. According to the image data downloaded in the mobile phone, the image for presentation is selected via each of the keys or the touch display, wherein the optical engine comprises a light source, a optical filter or a color disc, an integral rod, a condenser or lens array, a reflective microdisplay, a projection lens, and so on. As they are the prior arts, they will not be described here.

As for an optical video recording and photographing system, it is also configured in the casing 3 and electrically connected to the control circuit, and the control circuit is, capable of driving the optical video-recording and photographing system to execute the functions of video recording and photographing according to the operation of each of the keys 37 or the touch selection of the display 4.

Because the optical projecting system, the optical video recording and the photographing system are not the subject matter of the invention but the prior art, they are not to be described here.

The hand-held electronic device 2 with multi-functions of the invention further comprises a heat dissipating fan (not shown in the figures) configured in the casing 3. Accordingly, the heat dissipating fan is capable of spinning to blow air into the casing 3 via the above-mentioned inlet holes 341 and then out of the casing 3 via the above-mentioned outlet holes 311 and 321 for performing the function of heat dissipation in the casing 3.

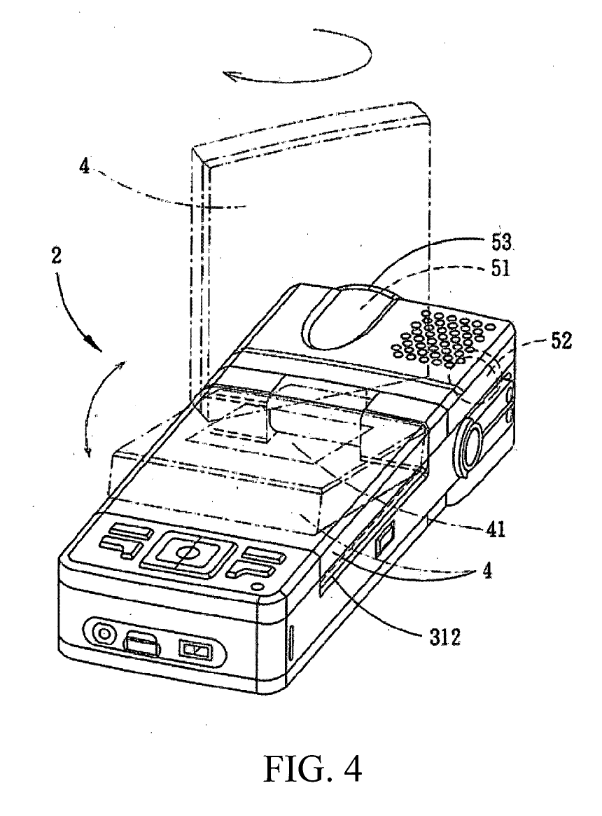

As shown in FIG. 1, when the hand-held electronic device 2 with multi-functions is idle, the cover 53 covers the projecting lens 51 and the display 4 is rotated to make the screen close to the hollow 312 of the casing 3. When the user wants to dial via the hand-held electronic device 2 with multi-functions, the display 4 only needs to be rotated to make the screen 41 face the user (as shown in FIG. 4) and enables him to operate the screen options or to dial, and at this time the control circuit executes the function of communication.

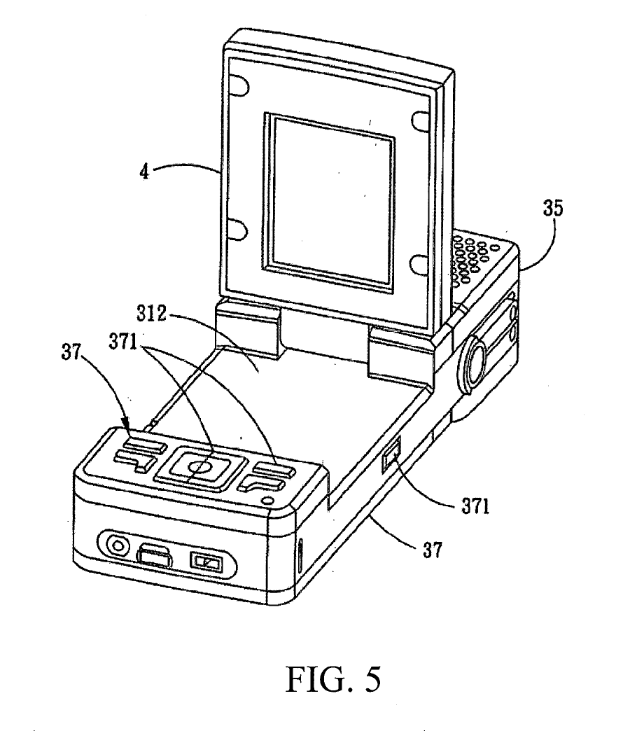

During video recording or photographing, the user is capable of rotating the display 4 as shown in FIG. 5, so as to watch the screen 41 for checking the image caught via a video lens 52, and to operate the keys 37 or to touch select via the screen options of display 4 at the same time. Because the part near the top side 35 of the casing 3 is thicker, when the bottom side 36 of the casing 3 is placed on a loader 6, such as a table, the front end of the casing 3 (the end near the top side 35) is capable of being raised. Therefore, even if the hand-held electronic device 2 with multi-functions is placed on the loader 6, the video lens, 52 is still capable of catching images completely.

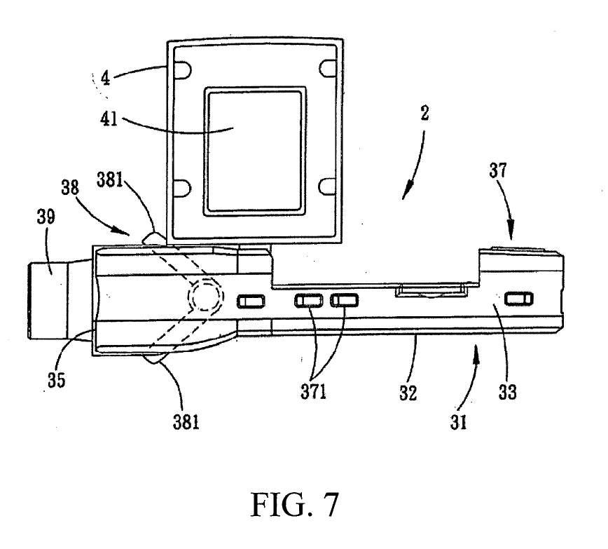

As shown in FIG. 6 and FIG. 7, two feet 381 of a stand frame 38 are capable of being pivoted oppositely to present an angle when projecting (as the positions show in FIG. 6), and then the stand frame 38 is placed on the loader 6 (as the table shown in FIG. 3) to make the hand-held electronic device 2 placed on the loader 6 more stably. Afterward, the cover 53 is taken off and a zoom lens 39 is installed on the projecting lens 51 (as shown in FIG. 1), so as to operate the keys 37 and to touch select via the screen options of the display 4 for projecting. At this time, the user is capable of projecting the image according to the image data selected. In view of the foregoing and referring to FIG. 3, because of the thickness of the part, near the top side 35, of the casing 3 and the thickness of the stand frame. 38, the front end of the casing 3 is capable of being raised higher. Therefore, the image of the screen 41 of the display 4 is a just 4:3 front view image, and the highness is high enough for projecting whole image of the screen 41 but not projecting a part of the image on the loader 6. Besides, the user is further capable of pivoting the display 4 (as shown in FIG. 7), so as to check the project image at the same time during projecting procedure.

Afterward, as shown in FIG. 1 and FIG. 2, because the light source generates a great quantity of heat during the projecting procedure, a heat dissipating fan is needed for dissipating heat. When the heat dissipating fan spins, air is blown into the casing 3 via the inlet holes 341, configured on the front side 31 and back side 32, and the air is exhausted out of the casing 3 via the outlet holes 311 and 321, so as to perform a heat dissipating mechanism.

In view of the aforementioned, the hand-held electronic device 2 with multi-functions of the invention is capable of providing selectively executing functions of communication, projection, video recording, and photographing according to the above-mentioned design, so as to achieve the effect of installing multi-functions in one set, which is also the purpose of the invention.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A hand-held electronic device with multi-functions, comprising:
a casing, having a plurality of operable keys;
a display, pivotally configured on the casing, being capable of rotating in different angles;
a control circuit, configured in the casing, being capable of selectively executing functions of communication, projection, video recording, and photographing;
an optical projecting system, configured in the casing and electrically connected to the control circuit, the control circuit being capable of driving the optical projecting system to execute the function of projection; and
an optical video recording and photographing system, configured in the casing and electrically connected with the control circuit, the control circuit being capable of driving the optical video recording and photographing system to execute the functions of video recording and photographing.

2. The hand-held electronic device of claim 1, wherein the optical projecting system comprises an optical engine which is configured in the casing and is capable of generating an image for projection, and a projecting lens which is exposed out of the casing and is capable of projecting the image generated by the optical engine.

3. The hand-held electronic device of claim 1, wherein the display is a touch screen.

4. The hand-held electronic device of claim 1, wherein the operable keys comprise a plurality of number keys for dialing and a plurality of functional keys for selectively executing functions of adjusting volume, selecting direction, viewing function list, and adjusting brightness.

5. The hand-held electronic device of claim 2, wherein the optical projecting system further comprises a zoom lens configured on the projecting lens.

6. The hand-held electronic device of claim 2, further comprising a cover for covering the projecting lens.

7. The hand-held electronic device of claim 1, further comprising a heat dissipating fan configured in the casing, the casing further comprising a plurality of inlet holes and outlet holes formed thereon, accordingly, the heat dissipating fan being capable of spinning to blow air into the casing via the inlet holes and then the air being exhausted out of the casing via the outlet holes, so as to dissipate heat in the casing.

8. The hand-held electronic device of claim 1, wherein a stand frame is pivotally configured on a side of the casing.

9. The hand-held electronic device of claim 8, wherein the stand frame has two feet capable of pivoting and moving between a close position and an open position.
